(19) United States
(12) Patent Application Publication
(10) Pub. No.: US 2026/0234031 A1
(43) Pub. Date: Aug. 13, 2026

(54) CARBON NANOMATERIAL-BASED WATER PURIFICATION SYSTEM

(71) Applicant: KING FAHD UNIVERSITY OF PETROLEUM AND MINERALS, Dhahran (SA)

(72) Inventors: Noor Tawfik ALARIFI, Dhahran (SA); Tawfik Abdo SALEH, Dhahran (SA)

(73) Assignee: KING FAHD UNIVERSITY OF PETROLEUM AND MINERALS, Dhahran (SA)

(21) Appl. No.: 19/051,110

(22) Filed: Feb. 11, 2025

(30) Foreign Application Priority Data
Feb. 9, 2025 (SA) 1020250892

(51) Int. Cl. C02F 1/44; C02F 101/10; C02F 101/16; C02F 101/20; C02F 101/32; C02F 101/34

(52) U.S. Cl. CPC C02F 1/44; C02F 2101/103; C02F 2101/105; C02F 2101/163; C02F 2101/20; C02F 2101/322; C02F 2101/345

(57) ABSTRACT

A system for water purification includes an inlet in fluid communication with a first column, the first column, in fluid communication with a second column, the second column, in fluid communication with an outlet, and the outlet where the first column is loaded with a first filtration material including polymer-modified graphene oxide carbon dots according to the structure

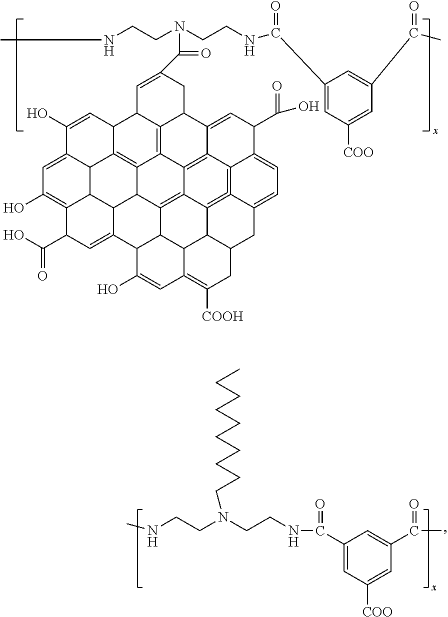

and
where the second column is loaded with a second filtration material including polymer-modified graphene oxide quantum dots according to the structure,

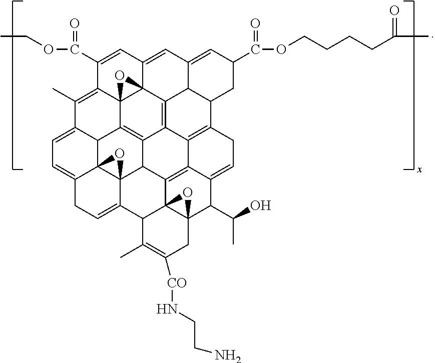

### CROSS-REFERENCE TO RELATED APPLICATIONS

The present disclosure claims the benefit of Saudi patent application Ser. No. 1020250892, filed Feb. 9, 2025, with the Saudi Authority for Intellectual Property Office, which is incorporated herein by reference in its entirety.

### BACKGROUND

### Technical Field

The present disclosure is directed towards water purification techniques, and more particularly, relates to a system of water purification including carbon nanomaterials.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present disclosure.

Water is indispensable for all living organisms on Earth. Water is also a useful solvent since many chemical compounds dissolve in water. With the advent of civilization, industrialization and overpopulation have had a negative impact on water supply and water quality. Worldwide industrial activities have resulted in pollution that has contaminated the environment and destroyed valuable resources. The need for fresh water is under tremendous strain due to the growth of industries such as petrochemicals, textiles, agrochemicals, and mining industries. The scarcity of water has created a serious threat to human survival, therefore appropriate recycling of effluent must be explored [See: Seah, M., et al., Greener synthesis of functionalized-GO incorporated TFN NF membrane for potential recovery of saline water from salt/dye mixed solution, Desalination, Volume 523, 2022, 115403]. A major environmental problem is the presence of pollutants in water and wastewater streams, including drugs, dyes, heavy metals, hydrocarbons, and salts. Most of these pollutants are harmful to human and aquatic lifeforms. Concentrations of organic micropollutants are frequently found in the nanogram to microgram per liter range. Organic pollutants may be discovered in soil sediments, freshwater reservoirs, natural bodies of water, and water treatment effluents [See: Yousaf, T., et al., Silane-grafted MXene (Ti₃C₂Tx) membranes for enhanced water purification performance, ACS Omega, 2022, 7, 23, 19502-19512]. Further, heavy metals such as strontium, lead, and magnesium are present in wastewater discharged by metallurgical industries, alloys-smelting, and naturally occurring mineral processing industries. The toxic metal ions are persistent and non-biodegradable; hence, long-term build-up of toxic metal ions has a negative influence on the environment and biodiversity, risking longevity of lifeforms. Furthermore, yet another major contaminant of water sources is sulfur and sulfur containing compounds. Although sulfur containing compounds are typically found in low concentration, they can nonetheless have an impact on safety, cause equipment to corrode, and have an unpleasant odor. Since sulfur diffuses into groundwater aquifers, it may affect biomes and aquatic habitats, making sulfur toxic from an environmental standpoint [See: Namaghi, H. et al., Ultra-desulfurization of sulfur recovery unit wastewater using thin film nanocomposite membrane, Separation and Purification Technology, Volume 221, 2019, pages 211-225]. Moreover, salts and heavy metal ions, including chloride, mercury, sulfate, lead, strontium, calcium, and potassium, are found in large quantities in seawater. During desalination, the scaling of pipes is caused by calcium, chloride, magnesium, and sulfate ions. Scaling or pipe fouling can be avoided by removing these divalent ions.

In order to purify water, several techniques and methods have been developed and used. One such method is membrane filtration. In particular, the membrane filtration method falls in between reverse osmosis and ultrafiltration in terms of a capacity of the membrane filtration method to reject ionic or molecular contaminants. In an example, a nanoporous membrane with pore diameters ranging from 1 nanometers (nm) to 10 nm is used in the membrane filtration process known as nanofiltration to separate molecules according to size. Polymer thin-film nanofiltration membranes are mostly employed in water treatment, medicines, food and beverage processing, and chemical manufacture, among other fields. The aforementioned method may filter or separate chemicals, disinfect water, and remove contaminants. The development of membranes with enhanced permeating flux has profited immensely from the discovery of nanostructured materials. Polymeric membranes have been surfaced and functionalized to provide properties like hydrophilicity and toughness to increase membrane water permeance.

Nanofiltration (NF) membranes are commonly used in wastewater and pre-treatment due to surface pore volume and distinctive functionality, which enable the NF membranes to selectively separate ions from wastewater of different valences and species. Further, more research into membrane surface modification not only improves water filtration and separation performance but simultaneously imparts antibacterial characteristics for antifouling purposes, thereby surface modification provides low resistance to water permeation. However, present methods and membranes are insufficient in meeting global clean water demand, hence, there is still a requirement for developing alternate designs, materials and methods for effective water treatment.

Accordingly, one object of the present disclosure is to provide a system for water purification and a method thereof, that may circumvent the drawbacks, such as, high operational costs, limited efficiency, less stability, and reduced reusability, of methods and materials known in the art.

### SUMMARY

In an exemplary embodiment, a system for water purification is described. The system for water purification includes an inlet in fluid communication with a first column, the first column, in fluid communication with a second column, the second column, in fluid communication with an outlet, and the outlet where the first column is loaded with a first filtration material including polymer-modified graphene oxide carbon dots according to the structure

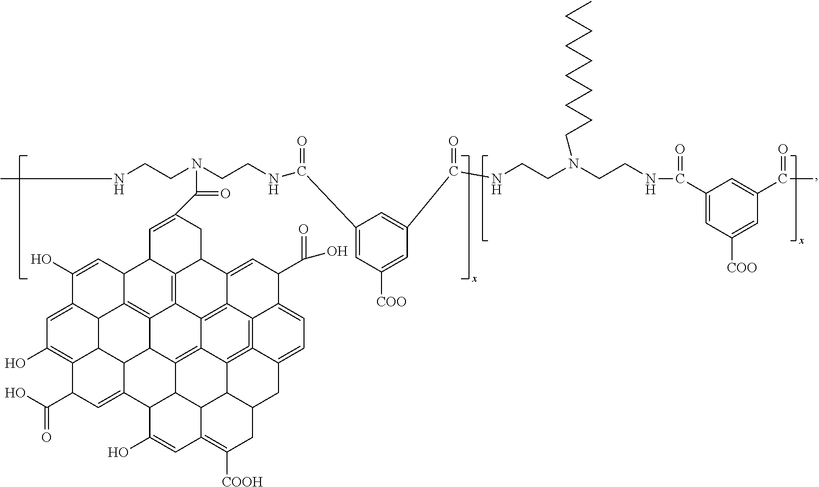

and
where the second column is loaded with a second filtration material including polymer-modified graphene oxide quantum dots according to the structure,

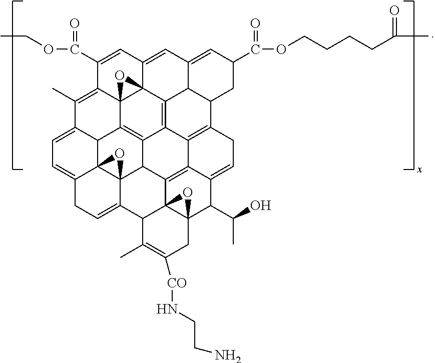

In some embodiments, the first filtration material occupies a portion of the first column in fluid communication with the inlet, and the volume of the first filtration material is in the range of 30% to 99% of the total volume of the first column.

In some embodiments, the first column further includes a first filter membrane and the first filter membrane occupies a portion of the first column in fluid communication with the first filtration material and the second column.

In some embodiments, the volume of the first filter membrane is in the range of 1 percent by volume (vol. %) to 70 vol. % of the total volume of the first column.

In some embodiments, the second filtration material occupies a portion of the second column in fluid communication with the first column, and the volume of the second filtration material is in the range of 30% to 99% of the total volume of the second column.

In some embodiments, the second column further includes a second filter membrane and the second filter membrane occupies a portion of the second column in fluid communication with the second filtration material and the outlet.

In some embodiments, the volume of the second filter membrane is in the range of 1 vol. % to 70 vol. % of the total volume of the second column.

In some embodiments, the aspect ratio of the first column is in a range from 3 to 7.

In some embodiments, the aspect ratio of the second column is in a range from 2 to 6.

In another exemplary embodiment, a method of water purification using the system is described. The method of water purification includes supplying contaminated water to the inlet, where the contaminated water is conveyed to the first column and second column. The water is purified by the first and second column to produce purified water which flows out of the outlet. The method further includes collecting purified water from the outlet, where the concentration of a contaminant is reduced in the purified water compared to the concentration of the contaminant in the contaminated water.

In some embodiments, the lead removal efficiency is greater than or equal to 95%.

In some embodiments, the arsenic removal efficiency is greater than or equal to 90%.

In some embodiments, the cobalt removal efficiency is greater than or equal to 95%.

In some embodiments, the zinc removal efficiency is greater than or equal to 95%.

In some embodiments, the barium removal efficiency is greater than or equal to 85%.

In some embodiments, the phosphate removal efficiency is greater than or equal to 85%.

In some embodiments, the nitrate removal efficiency is greater than or equal to 75%.

In some embodiments, the toluene removal efficiency is greater than or equal to 95%.

In some embodiments, the phenol removal efficiency is greater than or equal to 95%.

In some embodiments, the diesel fuel removal efficiency is greater than or equal to 90%.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A illustrates an exemplary schematic diagram of a system for water purification, according to certain embodiments.

FIG. 1B illustrates an exemplary schematic diagram of the system for water purification depicting a plurality of filtration material and membrane, according to certain embodiments.

FIG. 1C illustrates a top view of the system for water purification, according to certain embodiments.

FIG. 1D illustrates a side view of the system for water purification, according to certain embodiments.

FIG. 1E is an exemplary flow chart of a method of water purification using the system for water purification, according to certain embodiments.

FIG. 2 depicts a plurality of exemplary steps included in preparation of activated carbon dots from palm material, according to certain embodiments.

FIG. 3A depicts a plurality of exemplary steps included in the preparation of polymer grafted on activated carbon dots, according to certain embodiments.

FIG. 3B is an optical image of carbon dots/diethylene triamine/trimethylsilyl chloride (CDT) polymer nanocomposite used in a first column of the system for water purification, according to certain embodiments.

FIG. 3C is an optical image of a CDT polymer-modified membrane filter used in the first column of the system for water purification, according to certain embodiments.

FIG. 4 depicts a plurality of exemplary steps included in the preparation of graphene oxide from graphite, and synthesis of graphene oxide quantum dots, according to certain embodiments.

FIG. 5 depicts a plurality of exemplary steps included in the preparation of allyl grafted on graphene oxide quantum dots, according to certain embodiments.

FIG. 6A depicts a plurality steps included in the preparation of polymer grafted on graphene oxide quantum dots, according to certain embodiments.

FIG. 6B is an optical image of PGOD membrane used in a second column of the system for water purification, according to certain embodiments.

FIG. 7 is a graph depicting removal efficiency (%) of metal ions, for the system for water purification with the first and the second column, according to certain embodiments.

FIG. 8A is a graph depicting removal efficiency (%) of sulfate, chloride, nitrate, carbonate, phosphate, and bromide, for the system for water purification with the first and the second column, according to certain embodiments.

FIG. 8B is a graph depicting removal efficiency (%) of magnesium, calcium, sodium, potassium, and barium, for the system for water purification with the first and the second column, according to certain embodiments.

FIG. 9 is a graph depicting separation efficiency (%) of organic pollutants, for the system for water purification with the first and the second column, according to certain embodiments.

### DETAILED DESCRIPTION

When describing the present disclosure, the terms used are to be construed in accordance with the following definitions, unless a context dictates otherwise.

Embodiments of the present disclosure will now be described more fully hereinafter with reference to the accompanying drawings wherever applicable, in that some, but not all, embodiments of the disclosure are shown.

In the drawings, like reference numerals designate identical or corresponding parts throughout the several views. Further, as used herein, the words ‘a,’ ‘an’ and the like generally carry a meaning of ‘one or more,’ unless stated otherwise.

Furthermore, the terms ‘approximately,’ ‘approximate,’ ‘about,’ and similar terms generally refer to ranges that include the identified value within a margin of 20%, 10%, or preferably 5%, and any values therebetween.

The use of the terms ‘include,’ ‘includes’, ‘including,’ ‘have,’ ‘has,’ or ‘having’ should be generally understood as open-ended and non-limiting unless specifically stated otherwise.

As used herein, the term ‘contaminants’ refer to the harmful substances or pollutants that degrade the quality of water, air, soil, or food, making them unsafe or unsuitable for specific uses. In water, contaminants include biological agents like bacteria, viruses, and parasites; chemical substances such as heavy metals, pesticides, pharmaceuticals, and industrial chemicals; and physical materials like dirt, debris, and sediment. These contaminants can pose serious risks to human health, the environment, and ecosystems, depending on their type, concentration, and exposure levels.

In some embodiments, the contaminant may be a dye, a phenol, a polycyclic aromatic hydrocarbon, an herbicide, a pesticide, a persistent contaminant, or the like. In some embodiments, the contaminant is a dye. A dye is a colored substance that chemically binds to a material it may be intended to color. Generally, a dye is applied in solution, typically aqueous solution. Examples of dyes include, but are not limited to: acridine dyes, which are acridine and its derivatives such as acridine orange, acridine yellow, acriflavine, and gelgreen; anthraquinone dyes, which are anthroaquinone and its derivatives such as acid blue 25, alizarin, anthrapurpurin, carminic acid, 1,4-diamno-2,3-dihydroanthraquinone, 7,14-dibenzypyrenequinone, dibromoanthrone, 1,3-dihydroxyanthraquinone, 1,4-dihydroxyanthraquinone, disperse red 9, disperse red 11, indanthrone blue, morindone, oil blue 35, parietin, quinizarine green SS, remazol brilliant blue R, solvent violet 13, 1,2,4-trihydroxyanthraquinone, vat orange 1, and vat yellow 1; diaryl methane dyes such as auramine O, triarylmethane dyes such as acid fuchsin, aluminon, aniline blue WS, aurin, aurintricarboxylic acid, brilliant blue FCF, brilliant green, bromocresol green, bromocresol purple, bromocresol blue, bromophenol blue, bromopyrogallol red, chlorophenol red, coomassie brilliant blue, cresol red, O-cresolphthalein, crystal violet, dichlorofluorescein, ethyl green, fast green FCT, FIASH-EDT2, fluoran, fuchsine, green S, light green SF, malachite green, merbromin, metacresol purple, methyl blue, methyl violet, naphtholphthalein, new fuchsine, pararosaniline, patent blue V, phenol red, phenolphthalein, phthalein dye, pittacal, spirit blue, thymol blue, thymolphthalein, Victoria blue BO, Victoria blue R, water blue, xylene cyanol, and xylenol orange; azo dyes such as acid orange 5, acid red 13, alican yellow, alizarine yellow R, allura red AC, amaranth, amido black 10B, aniline yellow, arylide yellow, azo violet, azorubine, basic red 18, biebrich scarlet, Bismarck brown Y, black 7984, brilliant black BN, brown FK, chrysoine resorcinol, citrus red 2, congo red, D&C red 33, direct blue 1, disperse orange 1, eriochrome black T, evans blue, fast yellow AB, orange 1, hydroxynaphthol blue, janus green B, lithol rubine BK, metanil yellow, methyl orange, methyl red, methyl yellow, mordant brown 33, mordant red 19, naphthol AS, oil red O, oil yellow DE, orange B, orange G, orange GGN, para red, pigment yellow 10, ponceau 2R, prontosil, red 2G, scarlet GN, Sirius red, solvent red 26, solvent yellow 124, sudan black B, sudan I, sudan red 7B, sudan stain, tartrazine, tropaeolin, trypan blue, and yellow 2G; phthalocyanine dyes such as phthalocyanine blue BN, phthalocyanine Green G, Alcian blue, and naphthalocyanine, azin dyes such as basic black 2, mauveine, neutral red, Perkin's mauve, phenazine, and safranin; indophenol dyes such as indophenol and dichlorophenolindophenol; oxazin dyes; oxazone dyes; thiazine dyes such as azure A, methylene blue, methylene green, new methylene blue, and toluidine blue; thiazole dyes such as primuline, stains-all, and thioflavin; xanthene dyes such as 6-carboxyfluorescein, eosin B, eosin Y, erythosine, fluorescein, rhodamine B, rose bengal, and Texas red; fluorone dyes such as calcein, carboxyfluorescein diacetate succinimidyl ester, fluo-3, fluo-4, indian yellow, merbromin, pacific blue, phloxine, and seminaphtharhodafluor; or rhodamine dyes such as rhodamine, rhodamine 6G, rhodamine 123, rhodamine B, sulforhodamine 101, and sulforhodamine B.

A phenol is an organic compound consisting of a hydroxyl group (—OH) bonded directly to an aromatic hydrocarbon group. Examples of phenols include, but are not limited to, phenol (the namesake of the group of compounds), bisphenols (including bisphenol A), butylated hydroxytoluene (BHT), 4-nonylphenol, orthophenyl phenol, picric acid, phenolphthalein and its derivatives mentioned above, xylenol, diethylstilbestrol, L-DOPA, propofol, butylated hydroxyanisole, 4-tert-butylcatechol, tert-butylhydroquinone, carvacrol, chloroxyleol, cresol (including M-, O-, and P-cresol), 2,6-di-tert-butylphenol, 2,4-dimethyl-6-tert-butylphenol, 2-ethyl-4,5-dimethylphenol, 4-ethylguaiacol, 3-ethylphenol, 4-ethylphenol, flexirubin, mesitol, 1-nonyl-4-phenol, thymol, 2,4,6-tri-tert-butylphenol, chlorophenol (including 2-, 3-, and 4-chlorophenol), dichlorophenol (including 2,4- and 2,6-dichlorophenol), bromophenol, dibromo phenol (including 2,4-dibromophenol), nitrophenol, norstictic acid, oxybenzone, and paracetamol (also known as acetaminophen).

A polycyclic aromatic hydrocarbon (PAH) is an aromatic hydrocarbon composed of multiple aromatic rings. Examples of polycyclic aromatic hydrocarbons include naphthalene, anthracene, phenanthrene, phenalene, tetracene, chrysene, triphenylene, pyrene, pentacene, benzo[a]pyrene, corannulene, benzo[g,h,i]perylene, coronene, ovalene, benzo[c]fluorine, acenaphthene, acenaphthylene, benz[a]anthracene, benzo[b]fluoranthene, benzo[j]fluoranthene, benzo[k]fluoranthene, benzo[e]pyrene, cyclopenta[c,d]pyrene, dibenz[a,h]anthracene, dibenzo[a,e]pyrene, dibenzo[a,h]pyrene, dibenzo[a,i]pyrene, dibenzo[a,l]pyrene, fluoranthene, fluorine, indeno[1,2,3-c,d]pyrene, 5-methylchrysene, naphthacene, pentaphene, picene, and biphenylene.

An herbicide (also known as ‘weedkiller’) is a substance that is toxic to plants and may kill, inhibit the growth of, or prevent the germination of plants. Herbicides are typically used to control the growth of or remove unwanted plants from an area of land, particularly in an agricultural context. Examples of herbicides include, but are not limited to, 2,4-D, aminopyralid, chlorsulfuron, clopyralid, dicamba, diuron, glyphosate, hexazinone, imazapic, imazapyr, methsulfuron methyl, picloram, sulfometuron methyl, triclopyr, fenoxaprop, fluazifop, quizalofop, clethodim, sethoxydim, chlorimuron, foramsulfuron, halosulfuron, nicosulfuron, primisulfuron, prosulfuron, rimsulfuron, thofensulfuron, tribenuron, imazamox, imazaquin, flumetsulam, cloransulam, thiencarbazone, fluoxpyr, diflufenzopyr, atrazine, simazine, metribuzin, bromoxynil, bentazon, linuron, glufosinate, clomazone, isoxaflutole, topramezone, mesotrione, tembotrione, acifluorfen, formesafen, lactofen, flumiclorac, flumioxazin, fulfentrazone, carfentrazone, fluthiacet-ethyl, falufenacil, paraquat, ethalfluralin, pendimethalin, trifluralin, butylate, EPTC, ecetochlor,alachlor, metolachlor, dimethenamid, flufenacet, and pyroxasulfone.

A pesticide is a substance meant to prevent, destroy, or control pests including, but not limited to algae, bacteria, fungi, plants, insects, mites, snails, rodents, and viruses.

A pesticide intended for use against algae is known as an algicide. Examples of algicides include benzalkonium chloride, bethoxazin, cybutryne, dichlone, dichlorophen, diuron, endothal, fentin, isoproturon, methabenthiazuron, nabam, oxyfluorfen, pentachlorophenyl laurate, quinoclamine, quinonamid, simazine, terbutryn, and tiodonium.

A pesticide intended for use against bacteria is known as a bactericide. Examples of bactericides include antibiotics such as: aminoglycosides such as amikacin, gentamicin, kanamycin, neomycin, netilmicin, tobramycin, paromomycin, streptomycin, and spectinomycin; ansamycins such as geldanamycin, herbimycin, and rifaximin; carbacephems such as loracarbef; carbapenems such as ertapenem, doripenem, imipenem, and meropenem; cephalosporins such as cefadroxil, cefazolin, cephradine, cephapirin, cephalothin, cephalexin, cefaclor, cefoxitin, cefotetan, cefamandole, cefmetazole, cefonicid, cefprozil, cefuroxime, cefixime, cefdinir, cefditoren, cefoperazone, cefotaxime, cefpodoxime, cefazidime, ceftibuten, ceftizoxime, moxalactam, ceftriaxone, cefepime, cefaroline fosamil, and ceftobiprole; glycopeptides such as teicoplanin, vancomycin, telavancin, dalbavancin, and oritavancin; lincosamides such as clindamycin and lincomycin; lipopeptides such as daptomycin; macrolides such as azithromycin, clarithromycin, erythromycin, roxithromycin, telithromycin, spiramycin, and fidoxamicin; monobactams such as aztreonam; nitrofurans such as furazolidone and nitrofurantoin; oxazolidinones such as linezolid, posizolid, radezolid, and torezolid; penicillins such as amoxicillin, ampicillin, azlocillin, dicloxacillin, flucloxacillin, mezlocillin, methicillin, nafcillin, oxacillin, penicillins (including penicillin G and V), piperacillin, temocillin, and ticarcillin; polypeptides such as bacitracin, colistin, and polymyxin B; quinolones such as ciproflaxacin, enoxacin, gatifloxacin, gemifloxacin, levofloxacin, lomefloxacin, moxifloxacin, nadifloxacin, nalidixic acid, norfloxacin, ofloxacin, trovafloxacin, gepafloxacin, sparfloxacin, and temafloxacin; sulfonamides such as mafenide, sulfacetamide, sulfadiazine, sulfadithoxine, sulfamethizole, sulfamethoxazole, sulfanilamide, sulfasalazine, sulfisoxazole, and sulfonamidochrysoidine; tetracyclines such as demeclocycline, doxycycline, metacycline, minocycline, oxytetracycline, and tetracycline.

A pesticide intended for use against fungi is known as a fungicide. Examples of fungicides include acibenzolar, acypetacs, aldimorph, anilazine, aureofungin, azaconazole, azithiram, azoxystrobin, benalaxyl, benodanil, benomyl, benquinox, benthiavalicarb, binapacryl, biphenyl, bitertanol, bixafen, blasticidin-S, boscalid, bromuconazole, captafol, captan, carbendazim, carboxin, carpropamid, chloroneb, chlorothalonil, chlozolinate, cyazofamid, cymoxanil, cyprodinil, dichlofluanid, diclocymet, dicloran, diethofencarb, difenoconazole, diflumetorim, dimethachlone, dimethomorph, diniconazole, dinocap, dodemorph, edifenphos, enoxastrobin, epoxiconazole, etaconazole, ethaboxam, ethirimol, etridiazole, famoxadone, fenamidone, fenarimol, fenbuconazole, fenfuram, fenhexamid, fenoxanil, fenpropidin, fenpropimorph, ferbam, fluazinam, fludioxonil, flumorph, fluopicolide, fluopyram, fluoroimide, fluoxastrobin, flusilazole, flutianil, flutolain, flopet, fthalide, furalaxyl, guazatine, hexaconazole, hymexazole, imazalil, imibenconazole, iminoctadine, iodocarb, ipconazole, iprobenfos, iprodione, iprovalicarb, siofetamid, isoprothiolane, isotianil, kasugamycin, laminarin, mancozeb, mandestrobin, mandipropamid, maneb, mepanypyrim, mepronil, meptyldinocap, mealaxyl, metominostrobin, metconazole, methafulfocarb, metiram, metrafenone, myclobutanil, naftifine, nuarimol, octhilinone, ofurace, orysastrobin, oxadixyl, oxathiapiprolin, oxolinic acid, oxpoconazole, oxycarboxin, oxytetracycline, pefurazate, penconazole, pencycuron, penflufen, penthiopyrad, phenamacril, picarbutrazox, picoxystrobin, piperalin, polyoxin, probenzole, prochloraz, procymidone, propamocarb, propiconazole, propineb, proquinazid, prothiocarb, prothioconazole, pydiflumetofen, pyraclostrobin, pyrametostrobin, pyraoxystrobin, pyrazophos, pyribencarb, pyributicarb, pyrifenox, pyrimethanil, pyrimorph, pyriofenone, pyroquilon, quinoxyfen, quintozene, sedaxane, silthiofam, simeconazole, spiroxamine, streptomycin, tebuconazole, tebufloquin, tecloftalam, tecnazene, terbinafine, tetraconazole, thiabendazole, thifluzamide, thiophanate, thiram, tiadinil, tolclosfos-methyl, folfenpyrid, tolprocarb, tolylfluanid, triadimefon, triadimenol, triazoxide, triclopyricarb, tricyclazole, tridemorph, trifloxystrobin, triflumizole, triforine, validamycin, and vinclozolin.

A pesticide intended for use against plants is known as an herbicide as described above.

A pesticide intended for use against insects is known as an insecticide. Examples of insecticides are: organochlorides such as Aldrin, chlordane, chlordecone, DDT, dieldrin, endofulfan, endrin, heptachlor, hexachlorobenzene, lindane, methoxychlor, mirex, pentachlorophenol, and TDE; organophosphates such as acephate, azinphos-methyl, bensulide, chlorethoxyfos, chlorpyrifos, diazinon, chlorvos, dicrotophos, dimethoate, disulfoton, ethoprop, fenamiphos, fenitrothion, fenthion, malathion, methamdophos, methidathion, mevinphos, monocrotophos, naled, omethoate, oxydemeton-methyl, parathion, phorate, phosalone, phosmet, phostebupirim, phoxim, pirimiphos-methyl, profenofos, terbufos, and trichlorfon; carbamates such as aldicarb, bendiocarb, carbofuran, carbaryl, dioxacarb, fenobucarb, fenoxycarb, isoprocarb, methomyl; pyrethroids such as allethrin, bifenthrin, cyhalothrin, cypermethrin, cyfluthrin, deltamethrin, etofenprox, fenvalerate, permethrin, phenothrin, prallethrin, resmethrin, tetramethrin, tralomethrin, and transfluthrin; neonicotinoids such as acetamiprid, clothiandin, imidacloprid, nithiazine, thiacloprid, and thiamethoxam; ryanoids such as chlorantraniliprole, cyanthaniliprole, and flubendiamide.

A pesticide intended for use against mites is known as a miticide. Examples of miticides are permethrin, ivermectin, carbamate insecticides as described above, organophosphate insecticides as described above, dicofol, abamectin, chlorfenapyr, cypermethrin, etoxazole, hexythiazox, imidacloprid, propargite, and spirotetramat.

A pesticide intended for use against snails and other mollusks is known as a molluscicide. Examples of molluscicides are metaldehyde and methiocarb.

A pesticide intended for use against rodents is known as a rodenticide. Examples of rodenticides are warfarin, coumatetralyl, difenacoum, brodifacoum, flocoumafen, bromadiolone, diphacinone, chlorophacinone, pindone, difethialone, cholecalciferol, ergocalciferol, ANTU, chloralose, crimidine, 1,3-difluoro-2-propanol, endrin, fluroacetamide, phosacetim, pyrinuron, scilliroside, strychnine, tetramethylenedisulfotetramine, bromethalin, 2,4-dinitrophenol, and uragan D2.

A pesticide intended for use against viruses is known as a virucide. Examples of virucides are cyanovirin-N, griffithsin, interferon, NVC-422, scytovirin, urumin, virkon, zonroz, and V-bind viricide.

A persistent contaminant is a toxic organic chemical that adversely affects human and environmental health, can be transported by wind and water, and can persist for years, decades, or centuries owing to resistance to environmental degradation by natural chemical, biological, or photolytic processes. Persistent contaminants are regulated by the United Nations environment program 2001, and Stockholm convention on persistent contaminants. Examples of persistent contaminants are aldrin, chlordane, dieldrin, endrin, heptachlor, hexachlorobenzene, mirex, toxaphene, polychlorinated biphenyl (PCBs), dichlorodiphenyltrichloroethane (DDT), dioxins, polychlorinated dibenzofurans, chlordecone, hexachlorocyclohexane (α- and β-), hexabromodiphenyl ether, lindane, pentachlorobenzene, tetrabromodiphenyl ether, perfluorooctanesulfonic acid, endosulfans, and hexabromocyclododecane.

As used herein, the term ‘membrane’ refers to a porous structure that is capable of separating components of a homogeneous or heterogeneous fluid. In particular, ‘pores’ in the sense of the present disclosure indicate voids allowing fluid communication between different sides of the structure. More particular in use when a homogeneous or heterogeneous fluid is passed through the membrane, some components of the fluid can pass through the pores of the membrane into a ‘permeate stream’, some components of the fluid can be retained by the membrane and can thus accumulate in a ‘retentate’ and/or some components of the fluid can be rejected by the membrane into a ‘rejection stream’. Membranes can be of various thicknesses, with homogeneous or heterogeneous structures. Membranes can be in the form of flat sheets or bundles of hollow fibers. Membranes can also be in various configurations, including but not limited to spiral wound, tubular, hollow fiber, and other configurations identifiable to a skilled person upon a reading of the present disclosure. Membranes can also be classified according to their pore diameter. Membranes can be neutral or charged, and particle transport can be active or passive. The latter can be facilitated by pressure, concentration, and chemical or electrical gradients of the membrane process.

As used herein, the term ‘separation efficiency’ refers to the measure of how effectively a system or process can remove or separate a specific component from a mixture. It is typically expressed as a percentage, calculated by comparing the amount of the target substance removed to the total amount present. Higher separation efficiency indicates better performance in removing contaminants or separating components.

An aspect of the present disclosure is directed to a water purification system designed to effectively remove a wide range of contaminants from water. The system includes multiple filtration stages, each incorporating advanced materials such as polymer-modified graphene oxide carbon dots and polymer-modified graphene oxide quantum dots. These materials enhance the system's ability to target and remove contaminants, including heavy metals, organic compounds, and microorganisms. The system is adaptable to various water sources and is highly efficient in producing purified water suitable for diverse applications.

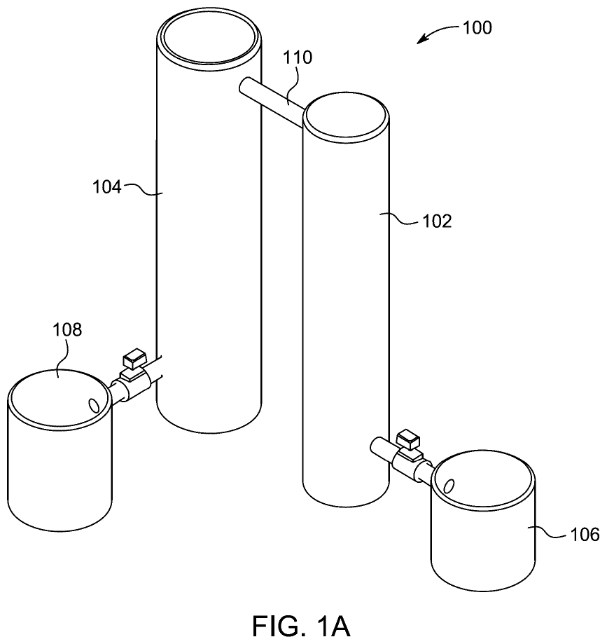

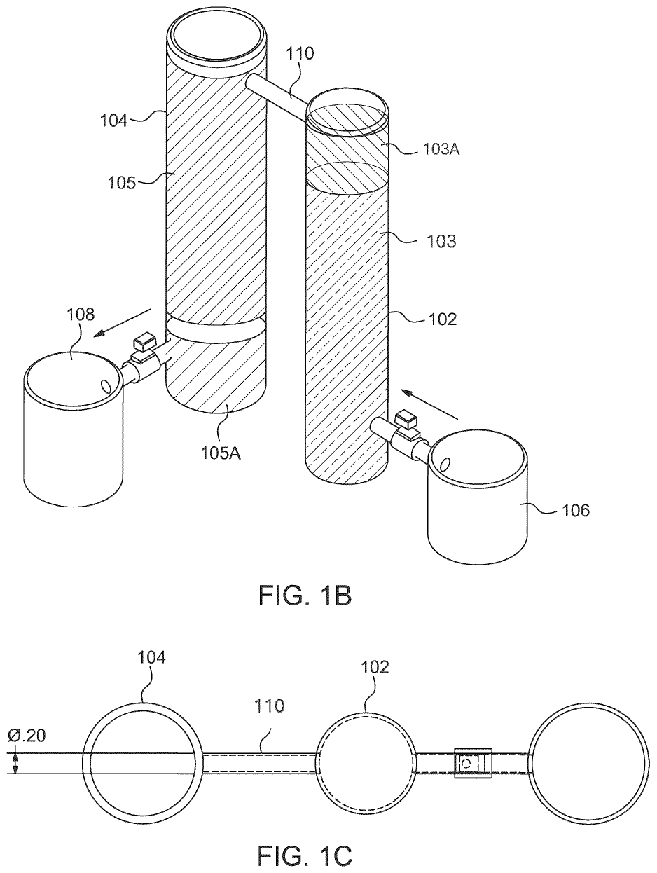

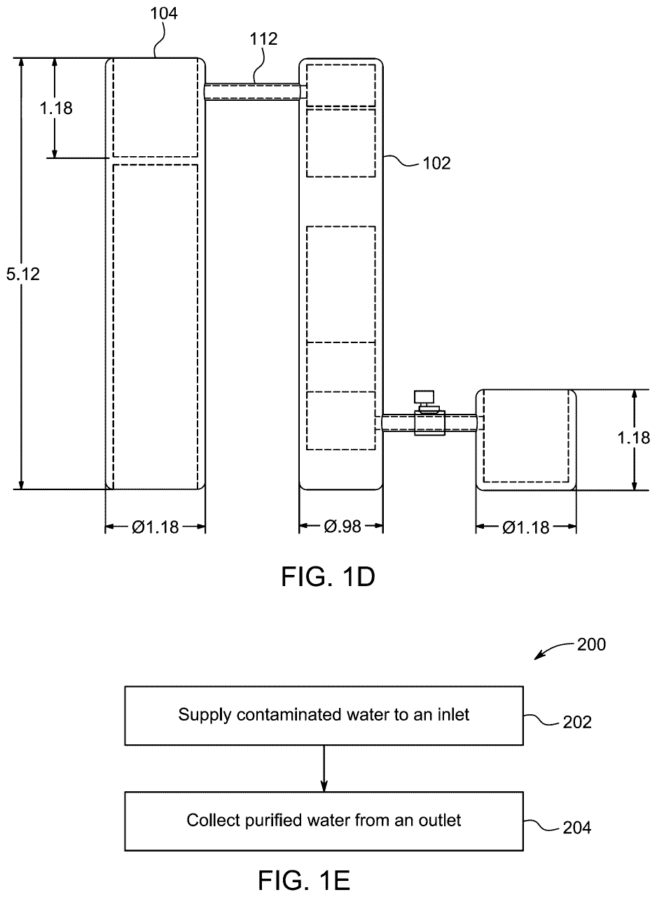

Referring to FIG. 1A, a system 100 for water purification is illustrated, according to certain embodiments. In particular, the system 100 is configured to effectively remove contaminants from water using a specific filtration material. Further, referring to FIG. 1B, a schematic diagram of the system 100 depicting a plurality of filtration material and filtration membrane is illustrated, according to certain embodiments. In some embodiments, the system 100 includes a first column 102 and a second column 104, each serving a distinct role in the water purification process. In some embodiments, the system 100 may include more columns or a combination thereof. Further, the system 100 includes an inlet 106, configured to introduce contaminated water into the system 100. The inlet 106 is in fluid communication with the first column 102, allowing the water to flow into the system 100 for initial treatment. The first column 102 is positioned upstream from the inlet 106 and serves as the initial stage of the filtration process. Further, as depicted in FIG. 1B, the first column 102 includes a first filtration material 103 including a polymer-modified graphene oxide carbon dots according to the structure provided below,

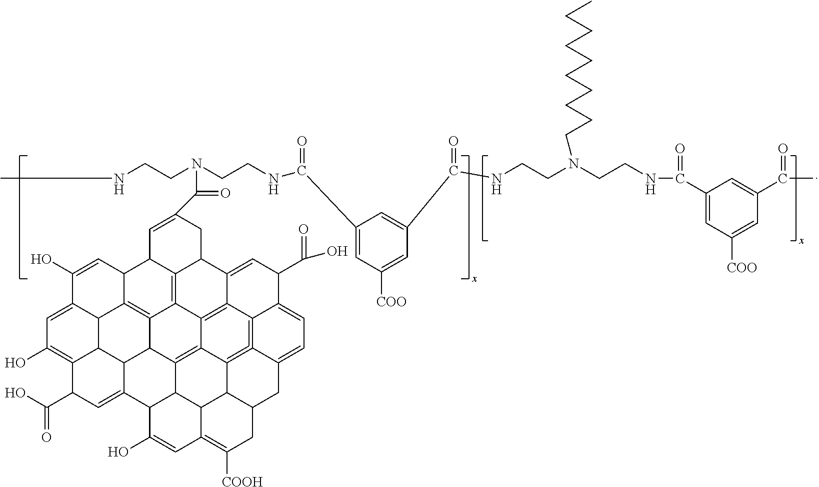

In one or more embodiments, n is an integer in a range from 1 to 10,000, preferably 3 to 1,000. In one or more embodiments, m is an integer in a range from 1 to 10,000, preferably 3 to 1,000.

The first filtration material 103 occupies a portion of the first column 102 in fluid communication with the inlet 106, and the volume of the first filtration material 103 is in the range of 1 to 99%, preferably 30% to 95, 40 to 90% or 50 to 80% of the total volume of the first column 102. The first column 102 further includes a first filter membrane 103A, and the first filter membrane 103A occupies a portion of the first column 102 in fluid communication with the first filtration material 103 and the second column 104. The volume of the first filter membrane 103A is in the range of 1 percent by volume (vol. %) to 99 vol. %, preferably 1 to 70 vol. %, 5 to 60 vol. % or 15 to 50 vol. % of the total volume of the first column 102. The aspect ratio of the first column 102 is in a range from 1 to 10, preferably 3 to 7 or 4 to 6. The aspect ratio of the columns refers to the ratio of a height of the first column 102 to a diameter or a width of the column 102. The first column 102 is fluidly coupled to the second column 104 via a conduit 110.

Further, in some embodiments, the polymer-modified graphene oxide carbon dots are used in the first column 102 due to a high surface area and chemical reactivity of the polymer-modified graphene dots. The modified graphene oxide may provide enhanced interaction between the filtration material and the contaminants, allowing the first column 102 to effectively trap and remove a wide range of pollutants. The first filter membrane preferably includes polymeric layers of the polymer formed from carbon dots/diethylene triamine/trimethylsilyl chloride. These monomers are deposited in a layered fashion to form a layered polymer film by layering a solution of carbon dots/diethylene triamine with alternating layers of a solution of trimethylsilyl chloride as described below in Example 5. This layered polymer film further aids in the filtration process. The second column 104 is in fluid communication with the first column 102, and is located downstream from the first column 102. The water, after passing through the first column 102, flows into the second column 104 for further purification.

The second column 104 is configured to contain a second filtration material 105 including polymer-modified graphene oxide quantum dots according to the structure provided below,

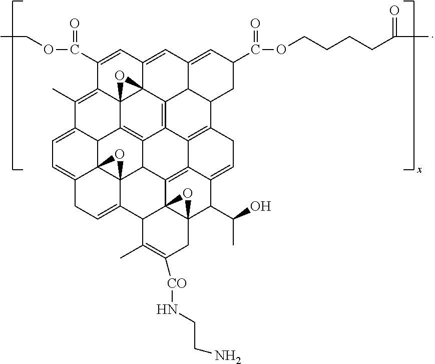

In one or more embodiments, x is an integer in a range from 1 to 10,000, preferably 3 to 1,000.

The second filtration material 105 occupies a portion of the second column 104 in fluid communication with the first column 102, and the volume of the second filtration material 105 is in the range of 1 to 99%, preferably 30% to 95, 40 to 90% or 50 to 80% of the total volume of the second column 104. The second column 104 further includes a second filter membrane 105A. In some embodiments, the second filter membrane 105A occupies a portion of the second column 104 in fluid communication with the second filtration material 105 and the outlet 108. The volume of the second filter membrane 105A is in the range of 1 vol. % to 99 vol. %, preferably 1 to 70 vol. %, 5 to 60 vol. % or 15 to 50 vol. % of the total volume of the second column 104. The second filter membrane preferably includes a polymeric layer of polymer-modified graphene oxide quantum dots on the filter membrane, which further aids in the filtration process. The aspect ratio of the second column 104 is in a range from 1 to 10, preferably 2 to 6 or 3 to 5.

The first column 102 and the second column 104 may contain additional filtration materials or mechanisms, such as activated carbon, UV treatment, or other materials, in order to remove the one or more contaminants. The second column 104 is connected to the outlet 108, through which the purified water exits the system 100. The outlet 108 is located at the end of the system 100, and it is where the treated water is discharged for further use. The outlet may be connected to any other typical storage or plumbing to remove the decontaminated water.

In some embodiments, the system 100 may include a manual control system, where the flow of water is regulated manually using valves at the inlet 106 and the outlet 108 to start or stop the flow. In some embodiments, the system 100 may feature an automated control system, utilizing level and pressure sensors to automatically control the water flow, adjusting based on real-time conditions. In some embodiments, a flow regulation system may be incorporated, where a flow regulator is used to maintain a consistent flow rate through the system 100. In some embodiments, the system 100 may include a pump-driven system, with pumps at both the inlet 106 and the outlet 108 to actively control the water flow, specifically, in cases requiring higher pressure. In some embodiments, the system 100 may include a backflow prevention system, where check valves are installed at the outlet 108 to prevent backflow, preventing the purified water from becoming contaminated. In additional embodiments, a hybrid control system may be employed, combining manual valves, automated sensors, and pumps to provide flexible control over the water flow under varying conditions.

The first column 102 and the second column 104 includes the first and second filtration materials 103, 105. As such, the structure of the polymer-modified graphene oxide carbon dots plays a role in the filtration process. The graphene oxide provides an efficient surface for contaminant adsorption, while the carbon dots enhance the overall effectiveness of the material, including in capturing and removing organic and inorganic pollutants. The polymer modification allows for greater stability, increased surface area, and tailored interactions with specific contaminants in the water.

The materials used in the system 100 may include, but are not limited to, stainless steel, high-density polyethylene (HDPE), polyvinyl chloride (PVC), glass, polyethylene glycol (PEG), polyvinyl alcohol (PVA), polyacrylamide (PAM), activated carbon, zeolite, ion-exchange resins, ceramic filters, rubber, silicone, flexible polymers, aluminum, engineered plastics, antimicrobial coatings, UV sterilization components, pH-adjusting agents, and flocculants.

The system 100 may include water collected from a plurality of sources, including, but are not limited to, seawater, brackish water, coastal water, wastewater, contaminated water, saline or contaminated saline water, and industrial wastewater streams. The system 100 may be desirable in many arid regions and in marine applications where freshwater supplies are limited, but large amounts of seawater, inland waterways, rivers, or other sources of salt-containing water are available. In certain embodiments, the system 100 may derive water from an oil or gas well, and/or the effluent of a chemical process (e.g., the effluent of a desalination system, or another chemical process), can also be used. In some embodiments, the system 100 for water decontamination may include a mixture of synthetic wastewater containing dyes, heavy metals, agricultural runoff, industrial effluents, oil and grease, food processing wastewater, a heavy metal solution, landfill leachate, textile wastewater, mining effluents, household wastewater, and pharmaceutical contaminants. The water may include one or more contaminants. The one or more contaminants may include heavy metals (e.g., lead, mercury, arsenic), pesticides, herbicides, nitrates, phosphates, pharmaceuticals (e.g., antibiotics, painkillers, hormones), solvents, oils, bacteria (e.g., E. coli), viruses, parasites, plastics, detergents, cyanide, sulfuric acid, and sediment. The water may include impurities such as lead, arsenic, cobalt, zinc, barium, phosphate, nitrate, toluene, phenol, diesel fuel, nickel, cadmium, chromium, mercury, copper, iron; salt ions such as magnesium, calcium, sodium, potassium, and barium while the tested anions include sulfate, chloride, nitrate, carbonate, phosphate, and bromide; organic pollutants such as toluene, isooctane, n-Hexane, decane, dodecane, phenol, diesel fuel, kerosene, olive oil and lubricating oil.

Referring to FIG. 1C and FIG. 1D, a schematic top view and a schematic side view of the system 100 are illustrated, respectively, according to certain embodiments. In particular, FIG. 1C and FIG. 1D depict exemplary dimensional specifications of the components included in the system 100 of FIG. 1A. These dimensions are given in a relative manner to a unit represented by 1, with other dimensions given as ratio relative to this. In one or more embodiments, the unit of 1 corresponds to a length in a range from 0.1 to 10 meters, preferably from 0.5 to 3 meters. In one or more embodiments, the unit 1 corresponds to a size appropriate for a given application. In particular, the width of the first column 102 is about 0.98, and the width of the second column 104 is about 1.18. The height of both the columns 102, 104 is about 5.12. Further, a width of the conduit 110 is about 0.20. In some embodiments, the aforementioned components of the system 100 may have other dimensional specifications than specified herein, particularly to suit an area of employment of the system 100.

FIG. 1E illustrates an exemplary flow chart of a method 200 of water purification using the system 100. The order in which the method 200 is described is not intended to be construed as a limitation, and any number of the described method steps may be combined in any order to implement the method 200. Additionally, individual steps may be removed or skipped from the method 200 without departing from the spirit and scope of the present disclosure.

At step 202, the method 200 includes supplying contaminated water to the inlet 106. The contaminated water is conveyed to the first column 102 and second column 104. The water is purified by the first and second columns 102, 104 to produce purified water which flows out of the outlet 108. Contaminated water enters through the inlet 106 and flows into the first column 102, where the contaminated water is treated by the first filtration material. The first column 102 removes a portion of contaminants from the water. The partially purified water then passes into the second column 104 including the second filtration material for additional filtration.

At step 204, the method 200 includes collecting purified water from the outlet 108. The concentration of a contaminant is reduced in the purified water compared to the concentration of the contaminant in the contaminated water. In one or more embodiments, the lead removal efficiency is greater than or equal to 95%. The arsenic removal efficiency is greater than or equal to 90%. The cobalt removal efficiency is greater than or equal to 95%. The zinc removal efficiency is greater than or equal to 95% . . . . The nickel removal efficiency is greater than or equal to 90%. The mercury removal efficiency is greater than or equal to 96%. The copper removal efficiency is greater than or equal to 90%. The cadmium removal efficiency is greater than or equal to 95%. The iron removal efficiency is greater than or equal to 95%. The chromium removal efficiency is greater than or equal to 90%.

The phosphate removal efficiency is greater than or equal to 85%. The nitrate removal efficiency is greater than or equal to 75%. The sulfate removal efficiency is greater than or equal to 75%. The chloride removal efficiency is greater than or equal to 70%. The carbonate removal efficiency is greater than or equal to 90%. The bromide removal efficiency is greater than or equal to 85%.

The barium removal efficiency is greater than or equal to 85%. The magnesium removal efficiency is greater than or equal to 75%. The calcium removal efficiency is greater than or equal to 75%. The sodium removal efficiency is greater than or equal to 55%. The potassium removal efficiency is greater than or equal to 75%.

The toluene removal efficiency is greater than or equal to 95%. The phenol removal efficiency is greater than or equal to 95%, preferably 96%, preferably 97%, preferably 98%. The diesel fuel removal efficiency is greater than or equal to 90%. The isooctane removal efficiency is greater than or equal to 97%. The n-hexane removal efficiency is greater than or equal to 97%. The decane removal efficiency is greater than or equal to 95%. The dodecane removal efficiency is greater than or equal to 97%. The kerosene removal efficiency is greater than or equal to 95%. The olive oil removal efficiency is greater than or equal to 95%. The lubricating oil removal efficiency is greater than or equal to 95%.

### EXAMPLES

The following examples demonstrate a system for water purification and a method thereof. The examples are provided solely for illustration and are not to be construed as limitations of the present disclosure, as many variations thereof are possible without departing from the spirit and scope of the present disclosure.

### Example 1: Materials and Equipment

The present disclosure includes a plurality of chemicals, as described hereinafter. KMnO₄, H₂SO₄ (96%, w/w), H₃PO₄ (85%, w/w), H₂O₂ (30%), urea, ammonium sulphate and ammonium phosphate were procured from Sigma Aldrich. Further, graphite powder and lubricating oil were procured from other sources. (18-crown-6)-2,3,11,12-tetracarboxylic acid, sodium hydroxide (NaOH), and nitric acid (HNO₃), were procured from Fluka and used as received, without further purification. Furthermore, potassium persulphate (K₂O₈S₂), nitrogen, toluene, n-hexane, cyclohexane, dichloromethane, chloroform, and ethanol were procured from Sigma Aldrich. Distillation water was obtained from in-house built distillation unit. In addition, the present disclosure included several compounds and equipment such as, but are not limited to, palm kernel shells or palm fiber, phosphoric acid, potassium hydroxide, zinc chloride, chemical activating agents, deionized water, grinding equipment, sieving equipment, and a furnace.

### Example 2: Procedure for Preparation of Carbon Dots from Palm (Carbonization)

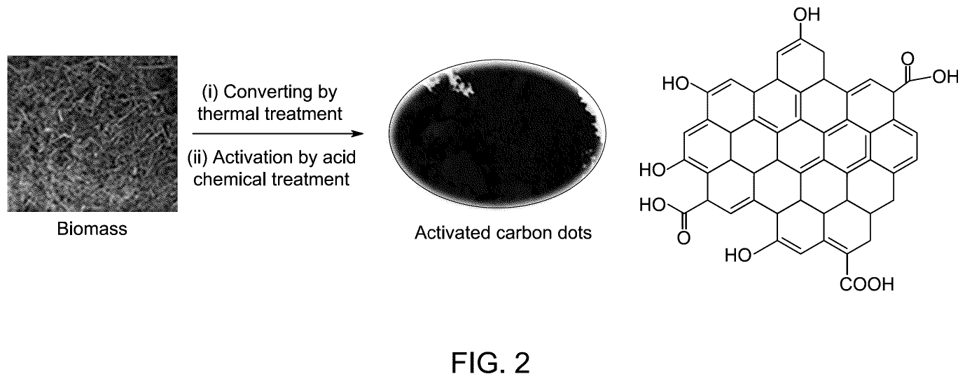

FIG. 2 illustrates a plurality of exemplary steps included in the preparation of activated carbon dots from palm material. In particular, the palm fibers were collected and cleaned to remove any dirt, debris, or residual oil. Further, the cleaned palm fibers were dried to remove moisture content present therein. The dried palm fibers were placed inside the furnace for carbonization, wherein the palm fibers were heated in an inert atmosphere to a temperature of about 500° C., with a rate of 2° C. per minute. The heating was maintained for 5 hours until the volatile components were driven off, producing a carbon-rich char. Moreover, the temperature was decreased to room temperature and the carbon-rich char was ground to powdered form using a jaw crusher to obtain a uniform size.

### Example 3: Activation of Obtained Carbon-Rich Char

In some embodiments, about 50 grams (g) of the obtained carbon-rich char was dispersed in 500 milliliters (mL) water. Further, 200 mL of H₃PO₄ was added as the chemical activating agent. The system was refluxed for 6 hours at about 90° C., and further the heating was turned off. The aforementioned steps were followed by cooling, and the resulting carbon was separated by filtration, and rinsed with distilled water until the pH of the resulting carbon reached around 6. Furthermore, the obtained carbon was dried and kept in airtight containers to prevent contamination and moisture absorption.

### Example 4: Preparation of Polymer-Modified Carbon Dots

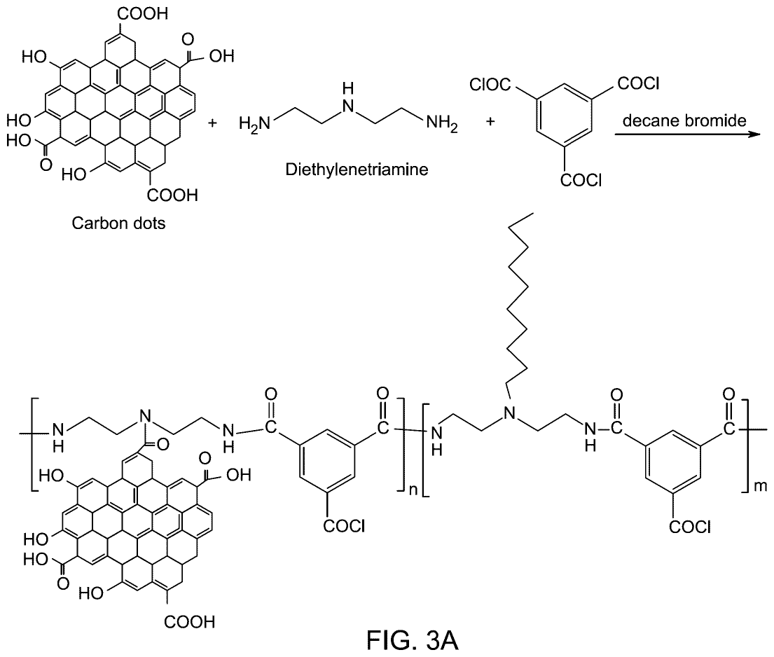

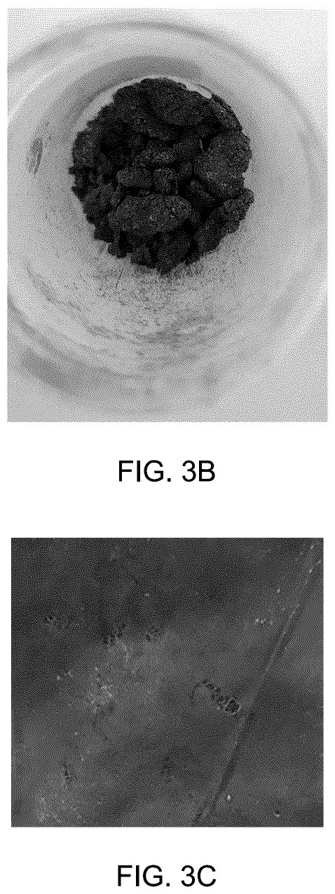

FIG. 3A illustrated a plurality of exemplary steps included in the preparation of polymer grafted on activated carbon dots. In particular, to prepare the polymer-modified carbon dots, the carbon dots were polymerized with diethylene triamine and trimethylsilyl chloride. For the polymerization process, about 1 g of carbon dots were dispersed in water, followed by addition of 10 mL diethylene triamine under stirring to form a first solution. Further, a second solution was prepared by dissolving 1 g trimethylsilyl chloride (1,3,5-benzenetricarbonyl trichloride) in 100 mL hexane under sonication. The second solution was dropwise added to the aqueous mixture of the first solution to initiate interfacial polymerization. Moreover, 5 mL of 1-bromodecane was added to the aforementioned mixture of the first solution and the second solution. The resultant system was kept under stirring for 24 hours. The obtained polymer of carbon dots/diethylene triamine/trimethylsilyl chloride (CDT), as shown in FIG. 3B, was collected and dried thereafter.

### Example 5: Synthesis of Polymer-Modified Carbon Dots Membrane Used in the First Column 102

Initially, a membrane support was prepared. Further, a solution of polyvinylidene fluoride (PVDF) was formed by mixing about 1.2 g of PVDF powder and 0.2 g polyvinylpyrrolidone (PVP), as an additive, in about 20 mL dimethyl formamide (DMF). The mixture was kept under stirring for 24 hours at 400 revolutions per minute (rpm), at room temperature. Furthermore, the obtained homogeneous solution was dispersed on a glass plate with a casting knife. Two minutes thereafter, the formed membrane was dipped in 500 mL distilled water and left overnight. The membrane was then transferred into fresh water to remove the impurities, followed by drying. The membrane was further activated by immersing the membrane in 0.1 molar (M) nitric solution. In addition, for the preparation of the membrane used in the first column 102, the carbon dots were mixed with diethylene triamine in aqueous media. In particular, 1 g of carbon dots were dispersed in water, followed by addition of 10 mL of diethylene triamine, under stirring. A second solution was made by dissolving 1 g trimethylsilyl chloride in 100 mL hexane under sonication. The membrane was coated with the second solution and subsequently with the first solution, two minutes thereafter. Moreover, five minutes thereafter, the steps as mentioned above were repeated five times to form polymeric layer of carbon dots/diethylene triamine/trimethylsilyl chloride (CDT) on the membrane, as shown in FIG. 3C.

### Example 6: Preparation of Graphene Oxide Quantum Dots

In order to synthesize graphene oxide quantum dots, a plurality of materials were obtained from Sigma Aldrich and were utilized as received. The plurality of materials included, but are not limited to, graphite powder, nitric acid (HNO₃), sodium nitrate (NaNO₃), sulfuric acid (H₂SO₄) (98%), potassium permanganate (KMnO₄), m-phenylenediamine (MPD), sodium chloride, sodium sulfate (Na₂SO₄), tridecane (C₁₃H₂₈), isooctane (C₈H₁₈), dodecane (C₁₂H₂₆), toluene (C₇H₈), industrial-grade n-hexane (a mixture of isomers), and Trimesoyl chloride (TMC). In addition, distilled water was used throughout the experiments.

### Example 7: Preparation of Graphene Oxide from Graphite

Graphene oxide was prepared from graphite following Hummer's method with several modifications. 5 g of graphite powder, 30 g of KMnO₄, and 25 g of NaNO₃ were homogeneously mixed. 0.5 g to 2 g of the above mixture was slowly added to a mixture of 180 mL H₂SO₄ (98%) and 20 mL phosphoric acid in ice bath, in each 4 to 10 minutes and under rigorous stirring. The obtained system was kept under stirring for 24 hours. The components were kept under stirring at 40° C. for 8 hours after removing the ice bath.

### Example 8: Preparation of Graphene Oxide Quantum Dots from Graphene Oxide

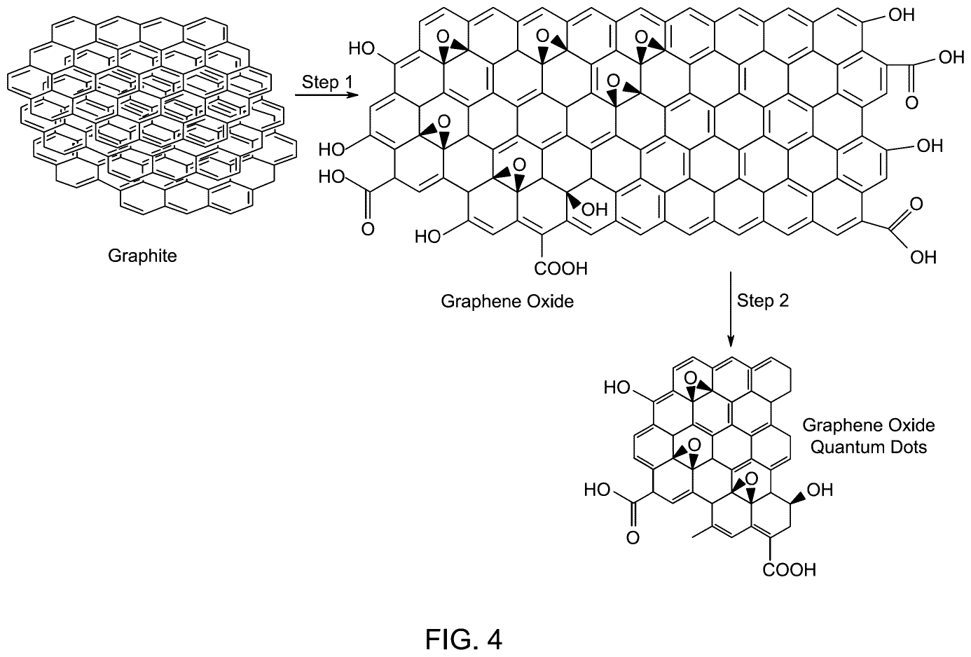

FIG. 4 illustrates a plurality of exemplary steps included in the preparation of graphene oxide from graphite, and synthesis of graphene oxide quantum dots. In furtherance to previously described procedures, a flask containing the above obtained mixtures was transferred to oil bath and refluxed with stirring for 12 hours at a temperature of more than 100° C. to 140° C. Further, the temperature was adjusted to about 30° C., and the mixture was added into the system under 30% H₂O₂, until the brown bright yellow color was observed. Furthermore, the system was cooled to room temperature and diluted with around 500 mL deionized water, prudently under stirring, in an ice medium having a temperature of about 0° C. to 5° C. Moreover, the stirring was turned off and the filtration was performed using a centrifuge with washing using 1 M HCl, followed by deionized water until pH was neutral. The collected graphene oxide was dried under a vacuum.

### Example 9: Synthesis of Allyl Graphene Dots

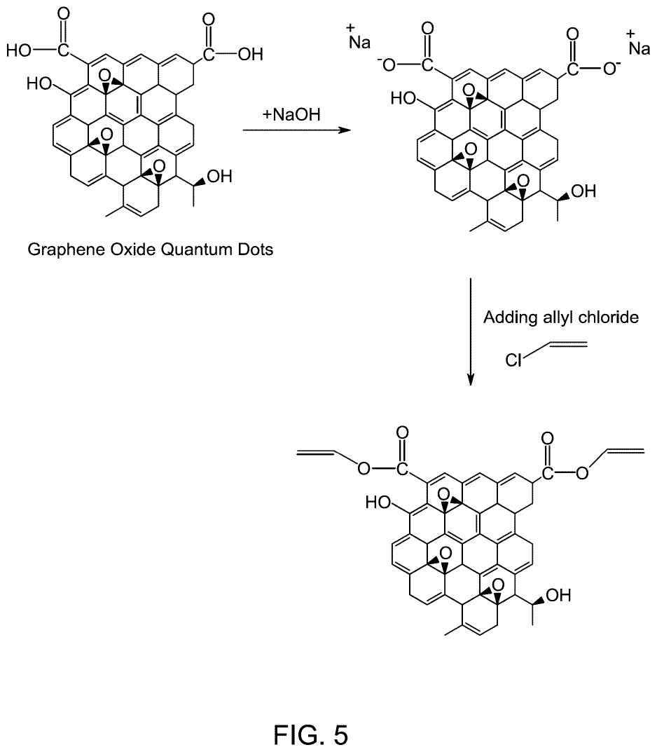

FIG. 5A illustrates a plurality of exemplary steps included in the preparation of allyl grafted on graphene oxide quantum dots. In particular, about 1 g of the obtained graphene oxide quantum dots were dispersed in 100 mL of distilled water. Further, 50 mL of 0.01 M sodium hydroxide was added and the system was heated and refluxed at 70° C. for about 8 hours. About 2 g of allyl chloride was added to the slurry and further reacted at a temperature of about 80° C. for 12 hours. Further, the product was filtered, washed with excess deionized water and ethanol, and dried at 60° C. for 12 hours to obtain allyl terminated graphene oxide quantum dots.

### Example 10: Preparation of Polymer-Modified Graphene Oxide Quantum Dots

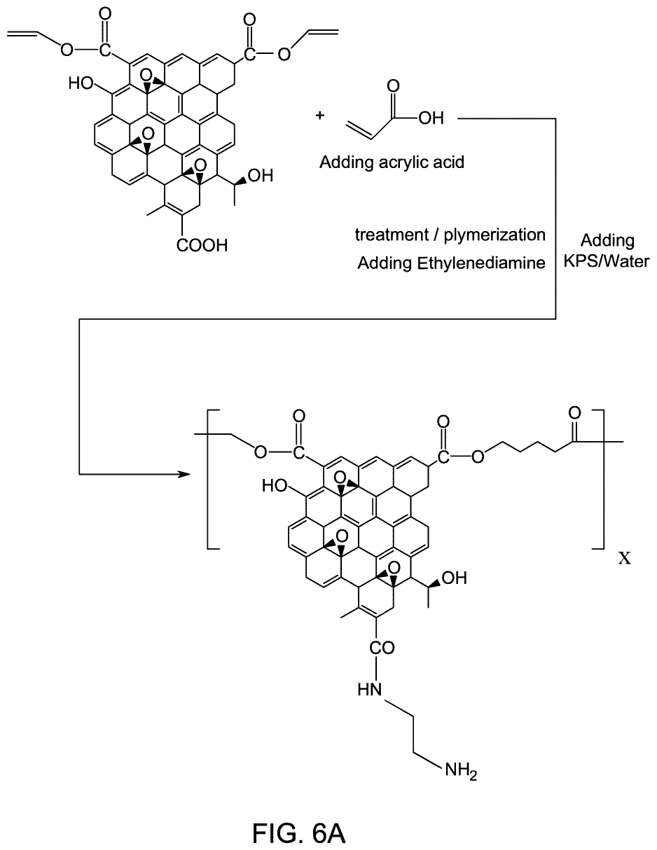

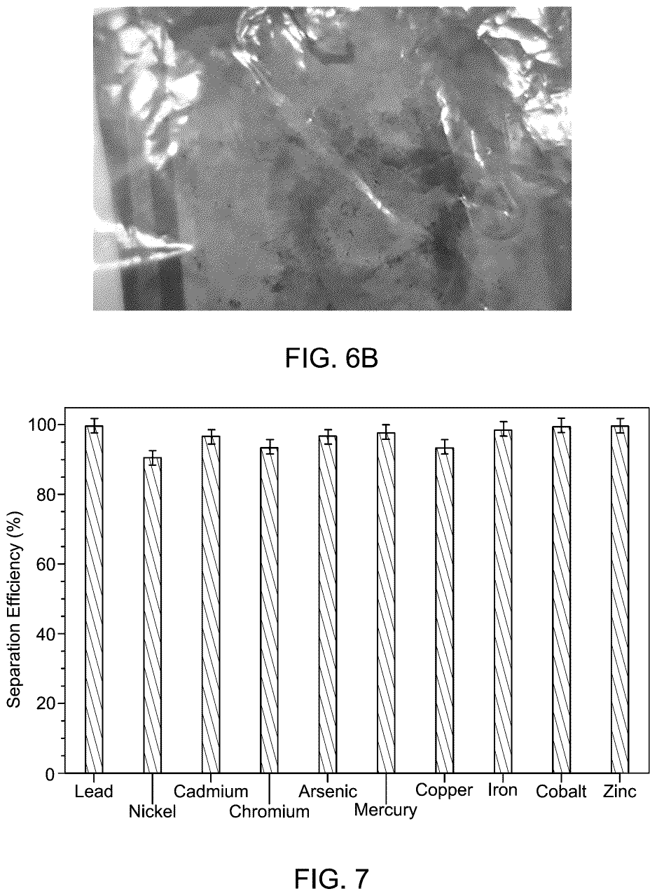

FIG. 6 illustrates a plurality of exemplary steps included in the preparation of polymer grafted on graphene oxide quantum dots. According to the present disclosure, the polymer-modified graphene was prepared via free radical polymerization. About 1 g of allyl terminated graphene oxide quantum dots and 8 g acrylic acid were added into a three-necked flask containing 100 mL deionized water equipped with a magnetic stirrer, condenser, and a nitrogen gas inlet. The solution was purged with nitrogen gas for 10 minutes in order to remove dissolved oxygen, the flow rate was reduced and maintained throughout the reaction time. Furthermore, 8 g EDA in 120 mL ethanol was added after 3 hours of heating at a temperature of 60° C. A solution of 0.1 g potassium persulfate (KPS) in 10 mL of deionized water was introduced as an initiator, gradually to initiate polymerization. The system was kept under stirring for 5 hours at a temperature of 80° C., followed by stirring at room temperature for 24 hours. The obtained polymer (PGOD) was precipitated in acetone and dried in a vacuum for 12 hours. The obtained polymer (PGOD), as shown in FIG. 6B, was used in the second column 104.

### Example 11: Synthesis of Polymer-Modified Graphene Oxide Quantum Dots Membrane Used in the Second Column 104

A membrane support was synthesized using the same steps and procedure as described above in example 5. The membrane was activated by immersing the membrane in 0.1 M nitric solution. Further, the polymer (PGOD) was prepared using the same steps as mentioned in example 10. The PGOD polymer was further coated on the PVDF membrane. The obtained PGOD membrane was used in the second column 104.

### Water Purification Test, and Separation Efficiency (%)

The system for water purification 100 was used and evaluated for its performance in wastewater purification and separation of pollutants. The water mixed with several pollutants including salts, metal ions, and organic compounds was allowed to inlet into the columns. The wastewater was allowed to flow using the pump to flow into the first column 102 and further into the second column 104 for further purification. The clean water was collected thereafter. The percentage removal and separation efficiency was calculated using the equation as provided below,

$$Removal efficiency ( \% ) = \frac{{C}_{0} - {C}_{f}}{{C}_{0}} \times 100 \% \qquad ( 1 )$$

where ‘C₀’ and ‘C_{f}’ denote the concentration of the pollutant in the water before and after the treatment.

The system 100 with the first and the second columns 102, 104 with the filtration materials 103, 105, was evaluated for wastewater treatment and pollutant separation. The system 100 and the filtration materials 103, 105 showed high efficiency in water treatment. The separation efficiency (%) of the filtration materials 103, 105 toward several metal ions (lead, nickel, cadmium, chromium, arsenic, mercury, copper, iron, cobalt, and zinc) from the water mixture is shown in FIG. 7. The results indicated high separation efficiency. The highest removal efficiency was toward the lead metal ions. Nickle ions were removed up to around 90% while copper removal was about 88%, being the least removed ions. In addition, mercury removal was around 96%.

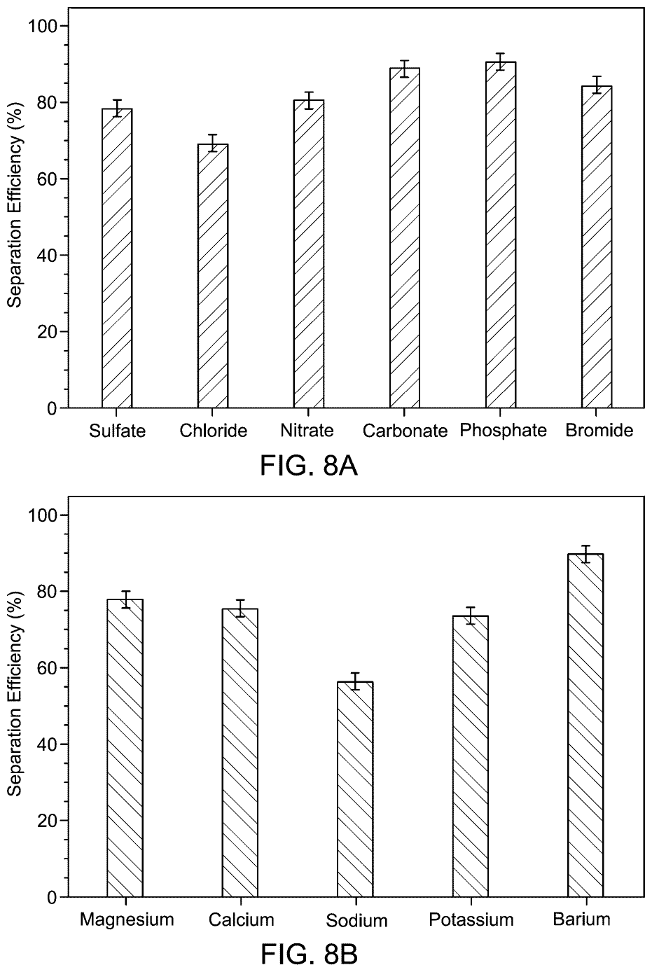

The separation efficiency (%) of the filtration materials 103, 105 toward several salt ions (cations include magnesium, calcium, sodium, potassium, and barium while the tested anions include sulfate, chloride, nitrate, carbonate, phosphate, and bromide) from the water mixture is shown in FIGS. 8A-8B. The results indicated high separation efficiency. Some ions were removed up to around 90% while the small in-size ions were less removed. However, the removal may be considered good. Thus, the system 100 may be used as a pretreatment unit before the membrane unit or reverse osmosis unit for water purification.

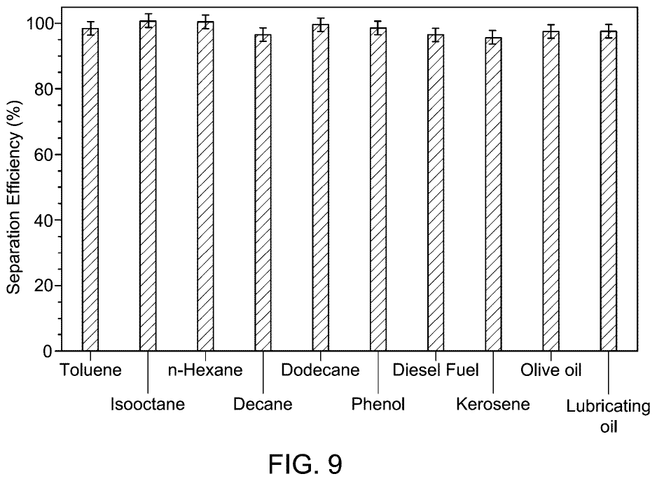

The separation efficiency (%) of the filtration materials 103, 105 toward several organic pollutants (toluene, isooctane, n-Hexane, decane, dodecane, phenol, diesel fuel, kerosene, olive oil and lubricating oil) from water mixture is shown in FIG. 9. The results indicated high separation efficiency. The highest removal efficiency was toward the isooctane, n-Hexane pollutants. Phenol was removed up to around 98% while kerosene removal was about 95%, being the least removed organic pollutant. All tested organic pollutants were removed to around or more than 95%. Hence, it may be concluded that the system 100 may be used for the removal of organic pollutants or oil from wastewater.

The aspects of the present disclosure provide the system 100 for water purification and a method 300 thereof. In particular, the system 100 includes the filtration materials 103, 105 and associated filtration membranes 103A, 105A. The filtration materials 103, 105 showed desirable efficiency in the removal of metallic, organic, and chemical pollutants. In some aspects, the system 100 and components included therein are modular in nature and are configured to retrofit a plurality of pre-existing water purification solutions. In this regard, the system 100 as described herein may provide an economical, yet efficient water purification solution, which may be re-used several times by replacing the filtration materials 103, 105 and the filtration membranes 103A, 105A.

Numerous modifications and variations of the present disclosure are possible in light of the above teachings. It is therefore to be understood that within the scope of the appended claims, the invention may be practiced otherwise than as specifically described herein.

1. A system for water purification, comprising:
a first column having an inlet disposed proximal to a bottom end thereof, wherein the first column is in fluid communication with a second column through a conduit disposed proximal to a top end of the first column and a top end of the second column;
wherein the second column has an outlet disposed proximal to a bottom end thereof; and
wherein the first column contains a first filtration material comprising polymer-modified graphene oxide carbon dots according to the structure 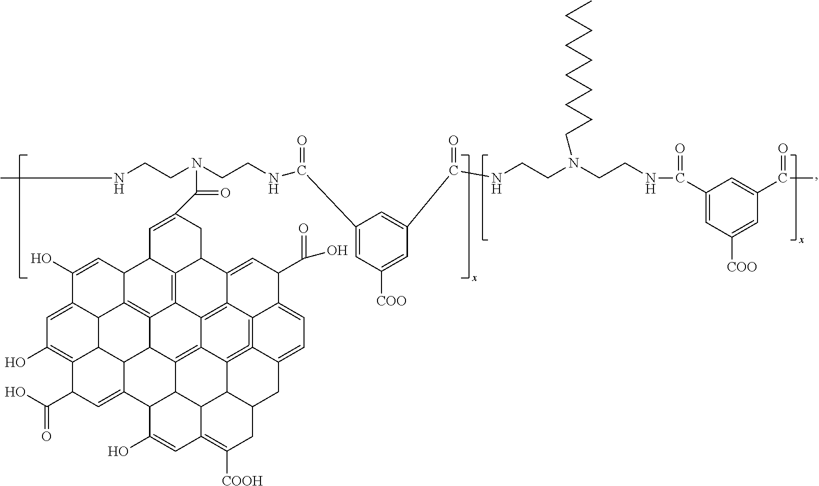
wherein n is an integer in a range from 1 to 10,000 and m is an integer in a range from 1 to 10,000,
wherein the second column contains a second filtration material comprising polymer-modified graphene oxide quantum dots according to the structure 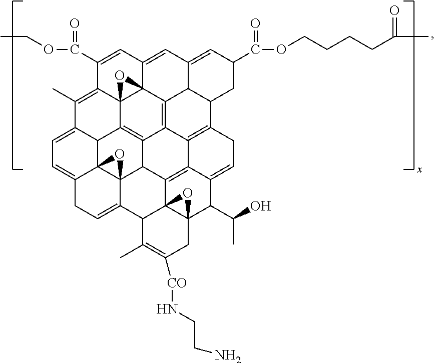
and
wherein x is an integer in a range from 1 to 10,000.

2. The system of claim 1, wherein the first filtration material occupies a portion of the first column in fluid communication with the inlet, and the volume of the first filtration material is in the range of 30 to 99% of the total volume of the first column.

3. The system of claim 1, wherein the first column further comprises a first filter membrane and the first filter membrane occupies a portion of the first column in fluid communication with the first filtration material and the second column.

4. The system of claim 3, wherein the volume of the first filter membrane is in the range of 1 to 70 vol % of the total volume of the first column.

5. The system of claim 1, wherein the second filtration material occupies a portion of the second column in fluid communication with the first column, and the volume of the second filtration material is in the range of 30 to 99% of the total volume of the second column.

6. The system of claim 1, wherein the second column further comprises a second filter membrane and the second filter membrane occupies a portion of the second column in fluid communication with the second filtration material and the outlet.

7. The system of claim 6, wherein the volume of the second filter membrane is in the range of 1 to 70 vol % of the total volume of the second column.

8. The system of claim 1, wherein the aspect ratio of the first column is in a range from 3 to 7.

9. The system of claim 1, wherein the aspect ratio of the second column is in a range from 2 to 6.

10. A method of water purification using the system of claim 1 comprising:
supplying contaminated water to the inlet, wherein the contaminated water is conveyed to the first column and second column,
wherein the water is purified by the first and second column to produce purified water which flows out of the outlet,
collecting purified water from the outlet, wherein the concentration of a contaminant is reduced in the purified water compared to the concentration of the contaminant in the contaminated water.

11. The method of claim 10, wherein the lead removal efficiency is greater than or equal to 95%.

12. The method of claim 10, wherein the arsenic removal efficiency is greater than or equal to 90%.

13. The method of claim 10, wherein the cobalt removal efficiency is greater than or equal to 95%.

14. The method of claim 10, wherein the zinc removal efficiency is greater than or equal to 95%.

15. The method of claim 10, wherein the barium removal efficiency is greater than or equal to 85%.

16. The method of claim 10, wherein the phosphate removal efficiency is greater than or equal to 85%.

17. The method of claim 10, wherein the nitrate removal efficiency is greater than or equal to 75%.

18. The method of claim 10, wherein the toluene removal efficiency is greater than or equal to 95%.

19. The method of claim 10, wherein the phenol removal efficiency is greater than or equal to 95%.

20. The method of claim 10, wherein the diesel fuel removal efficiency is greater than or equal to 90%.
